(19) United States
(12) Patent Application Publication
(10) Pub. No.: US 2010/0055459 A1
(43) Pub. Date: Mar. 4, 2010

(54) Nanoparticles Having Functional Additives for Self and Directed Assembly and Methods of Fabricating Same

(75) Inventors: Joseph M. Desimone, Chapel Hill, NC (US); Robert L. Henn, Raleigh, NC (US); Jake Sprague, Chapel Hill, NC (US)

Correspondence Address: MORGAN, LEWIS & BOCKIUS LLP, 1701 MARKET STREET, PHILADELPHIA, PA, 19103-2921, US

(73) Assignee: Liquidia Technologies, Inc., Research Triangle Park, NC (US)

(21) Appl. No.: 12/439,281

(22) PCT Filed: Aug. 30, 2007
(86) PCT No.: PCT/US07/19233

§ 371 Date: Sep. 30, 2009

Related U.S. Application Data
(60) Provisional application No. 60/841,581, filed on Aug. 30, 2006.

(51) Int. Cl. B32B 1/00; B27N 3/02

(52) U.S. Cl. 428/402; 264/109

(57) ABSTRACT

A plurality of nanoparticles, a structure assembled therefrom, a method of forming the structure, including a plurality of particles where each particle of the plurality of particles is configured with a substantially predetermined shape and a largest dimension less than about 100 micrometers, and where each particle of the plurality of particles includes an opening through the particle.

### CROSS REFERENCE TO RELATED APPLICATION(S)

This application is based off and claims priority to U.S. Provisional Patent Application No. 60/841,581, filed Aug. 30, 2006, which is incorporated herein by reference in its entirety.

### GOVERNMENT INTEREST

This invention was made in part with U.S. Government support sponsored by Defense Advanced Research Projects Agency as issued by U.S. Army Aviation and Missile Command under contract No. W31P4Q-07-C-0023. The U.S. Government, therefore, may have certain rights in this invention.

### TECHNICAL FIELD OF THE INVENTION

In general, this application relates to micro or nano sized particles. More particularly the particles are fabricated from low surface energy molds and include additives that can react to applied forces or contain functionality to propagate assembly.

### BACKGROUND OF THE FIELD OF THE INVENTION

The fabrication of materials having structural features of about 1 nanometer-1000 nanometer (nm) in size is a rapidly emerging area in materials science. Such nanostructured materials exhibit different macroscopic properties than those of more conventionally produced or engineered materials having structural features in the micrometer or larger size range. Moreover, it is known that nested levels of structural hierarchy in composite materials can impart superior properties over homogeneously structured materials. Certain biological materials, for example, exploit such design features and obtain superior performance characteristics.

Although nanostructured materials theoretically display considerable potential, their development has been limited by the current inability to conveniently and economically fabricate nano or micro scale components and assemble such components into larger objects and devices.

### SUMMARY

According to some embodiments of the present invention, a plurality of nanoparticles includes a plurality of particles wherein each particle of the plurality of particles is configured with a substantially predetermined shape and a largest dimension less than about 100 micrometers, and wherein each particle of the plurality of particles includes an opening through the particle.

In some embodiments, the substantially predetermined shape includes at least two substantially parallel surfaces. In certain embodiments, the opening includes a diameter of between about 10 percent and about 90 percent of the largest dimension of the particle. In other embodiments, the opening includes a predetermined shape.

According to some embodiments of the present invention, a method of assembling a structure includes subjecting a plurality of particles to a force to arrange the plurality of particles with respect to each other to form a structure wherein each particle of the plurality of particles includes a predetermined shape, a largest dimension less than about 100 micrometers, and a functional additive. In some embodiments, the force is then removed or the structure is subjected to a second force such that the plurality of particles disarrange.

In some embodiments, the plurality of particles is formed such that the functional additive is selectively positioned in a portion of the particles before subjecting the plurality of particles to a force. The functional additive may include magnetic material, thermally reactive material, chemically reactive material, electrically reactive material, radiation sensitive material, and surface energy.

In some embodiments, the force may be a magnetic force, a thermal force, an electric force, a chemical force, a biologic signal, a photonic signal, radiation, a mechanical force, and a physical force.

According to some embodiments of the present invention, a magnetically, electromagnetically, or electrically reactive structure, includes a plurality of particles, wherein each particle of the plurality of particles is configured with a substantially predetermined shape, a largest dimension less than about 100 micrometers, and a magnetic, electromagnetic, or electrically sensitive portion; and wherein a structure includes a predetermined arrangement of the plurality of particles and a changeable parameter of the structure, configured to change in response to a magnetic, electromagnetic, or electrical stimulus. The changeable parameter of the structure may include an optical, physical, chemical, or electrical parameter of the structure. The changeable parameter may also include refractive index, reflectiveness, diffraction, color, transmission, translucence, and opaqueness. Additionally, the changeable parameter may include hardness, toughness, strength, elasticity, density, surface energy, roughness, charge, electric field, hydrophilicity, hydrophobicity, and magnetic field.

In some embodiments, each particle of the plurality of particles has a cross section, and the predetermined shape of the cross section of each particle of the plurality of particles may be a circle, a triangle, a cube, a rectangle, a hexagon, an octagon, a polygon, a parallelogram, a diamond, and a crescent.

According to a further embodiment of the present invention, a chemically reactive structure includes a plurality of particles, wherein each particle of the plurality of particles is configured with a substantially predetermined shape, a largest dimension less than about 100 micrometers, and a chemically sensitive portion; and wherein a structure includes a predetermined arrangement of the plurality of particles and a changeable parameter of the structure, configured to change in response to a chemical stimulus.

According to a further embodiments of the present invention, a physically reactive structure includes a plurality of particles, wherein each particle of the plurality of particles is configured with a substantially predetermined shape, a largest dimension less than about 100 micrometers, and a physically sensitive component; and wherein a structure includes a predetermined arrangement of the plurality of particles and a changeable parameter of the structure, configured to change in response to a physical stimulus.

### BRIEF DESCRIPTION OF THE FIGURES

FIG. 1 shows one embodiment of the particle of the present invention.

FIG. 2 shows one embodiment of a master of the present invention.

FIG. 3 shows a particle that includes a functional additive according to an embodiment of the present invention.

FIG. 4 shows fabrication of particles with a functional additive and organization of that functional additive within the particle according to an embodiment of the present invention.

FIG. 5 shows fabrication of particles with an electrically active additive and organization of that additive within the particle according to an embodiment of the present invention.

FIG. 6 illustrates one embodiment of a particle of the present invention and its segments.

FIG. 7 reflects fluorescence micrography showing a hydrophobic segment substantially confined to one segment of the particle according to one embodiment of the present invention.

FIG. 8 shows multiple particles that include functional additives wherein the particles arrange in response to an applied force according to an embodiment of the present invention.

FIGS. 9A-9B shows particles including additives according to an embodiment of the present invention.

FIGS. 10A-10C show particles tessellated into a plane according to an embodiment of the present invention.

FIG. 11 shows planar particles organized into a larger plane according to an embodiment of the present invention.

FIG. 12 shows particles fabricated according to an embodiment of the present invention and shows orthogonal concatenation of the particles according to an embodiment of the present invention.

FIG. 13 shows further orthogonal concatenation of particles fabricated according to an embodiment of the present invention.

FIG. 14 shows a fractal structure formed by particles fabricated according to an embodiment of the present invention.

FIG. 15 shows disc-shaped hex-nut particles forming rod-like assemblies according to one embodiment of the present invention.

FIGS. 16-17 show particles with one hydrophilic and one hydrophobic face according to one embodiment of the present invention.

FIG. 18 shows particles assembled into small areas of close-packed hex-nut particles according to one embodiment of the present invention.

FIGS. 19A-19D shows boomerang-shaped particles were harvested on a HEMA harvesting substrate according to one embodiment of the present invention.

FIG. 20 illustrates close packed hex nut particles according to one embodiment of the present invention.

FIG. 21 shows dilute suspensions of rectangular column particles with end-to-end assembly according to one embodiment of the present invention.

FIG. 22 shows distinct phases such as out-of-plane hexagonal packing and in plane, quasi-ordered packing according to one embodiment of the present invention.

FIG. 23 shows TMPTA particles released from a surface, in contact with a water drop, and formed into an assembled structure according to an embodiment of the present invention.

FIGS. 24A-24C shows one embodiment of particles of the present invention migrating toward a magnet.

### DETAILED DESCRIPTION OF EMBODIMENTS OF THE INVENTION

One embodiment of the present invention includes precision shaped micro or nano sized particles having a specific desired shape. Another embodiment of the present invention includes the ability to manipulate the particles into ordered arrangements and structures. Another embodiment of the present invention includes methods for fabricating such particles and structures.

Particles

Particles of some embodiments of the present invention are, in some embodiments, molded in low surface energy molds, methods, and materials described in the following patent applications: U.S. Provisional Patent Application Ser. No. 60/691,607, filed Jun. 17, 2005; U.S. Provisional Patent Application Ser. No. 60/714,961, filed Sep. 7, 2005; U.S. Provisional Patent Application Ser. No. 60/734,228, filed Nov. 7, 2005; U.S. Provisional Patent Application Ser. No. 60/762,802, filed Jan. 27, 2006; U.S. Provisional Patent Application Ser. No. 60/799,876 filed May 12, 2006; WO 07/024323 (PCT International Application Serial No. PCT/US06/23722), filed Jun. 19, 2006; U.S. Provisional Patent Application Ser. No. 60/798,858, filed May 9, 2006; U.S. Provisional Patent Application Ser. No. 60/799,876, filed May 12, 2006; U.S. Provisional Patent Application Ser. No. 60/800,478, filed May 15, 2006; U.S. Provisional Patent Application Ser. No. 60/811,136, filed Jun. 5, 2006; U.S. Provisional Patent Application Ser. No. 60/817,231, filed Jun. 27, 2006; U.S. Provisional Patent Application Ser. No. 60/831,372, filed Jul. 17, 2006; U.S. Provisional Patent Application Ser. No. 60/833,736, filed Jul. 27, 2006; WO 07/030698 (PCT International Patent Application Serial No. PCT/US06/034997), filed Sep. 7, 2006); WO 05/01466 (PCT International Patent Application Serial No. PCT/US04/42706), filed Dec. 20, 2004, which is based on and claims priority to U.S. Provisional Patent Application Ser. No. 60/531,531, filed Dec. 19, 2003, U.S. Provisional Patent Application Ser. No. 60/583,170, filed Jun. 25, 2004, U.S. Provisional Patent Application Ser. No. 60/604,970, filed Aug. 27, 2004, PCT International Patent Application Serial No. PCT/US06/34997; PCT International Patent Application Serial No. PCT/US06/043305; PCT International Patent Application Serial No. PCT/US07/002476; PCT International Patent Application Serial No. PCT/US07/011220; PCT International Patent Application Serial No. PCT/US07/011752; and PCT International Patent Application Serial No. PCT/US07/16248 each of which is incorporated herein by reference in its entirety including all references cited therein.

In some embodiments, a particle is formed from a flowable substance, such as for example a liquid, semi-liquid, liquid at room temperature, or a powder. In some embodiments, a particle is formed from a power substance which is suspended or dissolved into a liquid or solvent before or after it is introduced into the mold cavities.

In some embodiments, a particle is formed from a flowable substance, such as for example a liquid or a powder. In some embodiments, a plurality of particles may be formed from the low surface energy molds of the above-referenced patent applications.

Particle Size

In one embodiment, the largest dimension of the particle is less than about 100 microns. In another embodiment, the largest dimension of the particle is less than about 90 microns. In another embodiment, the largest dimension of the particle is less than about 80 microns. In another embodiment, the largest dimension of the particle is less than about 70 microns. In another embodiment, the largest dimension of the particle is less than about 60 microns. In another embodiment, the largest dimension of the particle is less than about 50 microns. In another embodiment, the largest dimension of the particle is less than about 40 microns. In another embodiment, the largest dimension of the particle is less than about 30 microns. In another embodiment, the largest dimension of the particle is less than about 20 microns. In another embodiment, the largest dimension of the particle is less than about 10 microns. In another embodiment, the largest dimension of the particle is less than about 9 microns. In another embodiment, the largest dimension of the particle is less than about 8 microns. In another embodiment, the largest dimension of the particle is less than about 7 microns. In another embodiment, the largest dimension of the particle is less than about 6 microns. In another embodiment, the largest dimension of the particle is less than about 5 microns. In another embodiment, the largest dimension of the particle is less than about 4 microns. In another embodiment, the largest dimension of the particle is less than about 3 microns. In another embodiment, the largest dimension of the particle is less than about 2 microns. In another embodiment, the largest dimension of the particle is less than about 1 microns.

In another embodiment, the largest dimension of the particle is less than about 950 nanometers. In another embodiment, the largest dimension of the particle is less than about 900 nanometers. In another embodiment, the largest dimension of the particle is less than about 850 nanometers. In another embodiment, the largest dimension of the particle is less than about 800 nanometers. In another embodiment, the largest dimension of the particle is less than about 750 nanometers. In another embodiment, the largest dimension of the particle is less than about 700 nanometers. In another embodiment, the largest dimension of the particle is less than about 650 nanometers. In another embodiment, the largest dimension of the particle is less than about 600 nanometers. In another embodiment, the largest dimension of the particle is less than about 550 nanometers. In another embodiment, the largest dimension of the particle is less than about 500 nanometers. In another embodiment, the largest dimension of the particle is less than about 450 nanometers. In another embodiment, the largest dimension of the particle is less than about 400 nanometers. In another embodiment, the largest dimension of the particle is less than about 350 nanometers. In another embodiment, the largest dimension of the particle is less than about 300 nanometers. In another embodiment, the largest dimension of the particle is less than about 250 nanometers. In another embodiment, the largest dimension of the particle is less than about 200 nanometers. In another embodiment, the largest dimension of the particle is less than about 150 nanometers. In another embodiment, the largest dimension of the particle is less than about 100 nanometers. In another embodiment, the largest dimension of the particle is less than about 50 nanometers. In another embodiment, the largest dimension of the particle is less than about 45 nanometers. In another embodiment, the largest dimension of the particle is less than about 40 nanometers. In another embodiment, the largest dimension of the particle is less than about 35 nanometers. In another embodiment, the largest dimension of the particle is less than about 30 nanometers. In another embodiment, the largest dimension of the particle is less than about 25 nanometers. In another embodiment, the largest dimension of the particle is less than about 20 nanometers. In another embodiment, the largest dimension of the particle is less than about 15 nanometers. In another embodiment, the largest dimension of the particle is less than about 10 nanometers. In another embodiment, the largest dimension of the particle is less than about 9 nanometers. In another embodiment, the largest dimension of the particle is less than about 8 nanometers. In another embodiment, the largest dimension of the particle is less than about 7 nanometers. In another embodiment, the largest dimension of the particle is less than about 6 nanometers. In another embodiment, the largest dimension of the particle is less than about 5 nanometers. In another embodiment, the largest dimension of the particle is less than about 4 nanometers. In another embodiment, the largest dimension of the particle is less than about 3 nanometers. In another embodiment, the largest dimension of the particle is less than about 2 nanometers. In another embodiment, the largest dimension of the particle is less than about 1 nanometer.

A largest dimension may be a linear dimension from one side of a particle to the other side of the particle.

Particle Shape

In some embodiments, each particle of a plurality of particles is configured with a substantially predetermined shape. In some embodiments, the manufacturing process may produce particles with inherent variations in shape. In some embodiments, the shape of the particles may vary from the shape of the mold. In some embodiments, the shape of the particles may vary from the shape of other particles in the plurality of particles. In certain embodiments, the variations of the shape of the particles may be nanoscale variations. In other embodiments, the particles may have substantially identical shapes. In certain embodiments, the particles may have identical shapes.

Some shape-specific particle geometries include, but are not limited to, cylinders with varying aspect ratio, two dimensional chiral 30-60-90 degree angle triangle, rhombus, regular hexagonal plate with or without an opening, geometric shapes, self-affine fractal, notched shapes such as a pentagon, boomerang shaped, penrose tiles, combinations thereof, and the like.

In some embodiments, each particle has a cross section with a predetermined shape. The predetermined shape of the particle cross section may include but is not limited to a circle, a triangle, a cube, a rectangle, a hexagon, an octagon, a polygon, a parallelogram, a diamond, a crescent, combination thereof, and the like.

In some embodiments, the substantially predetermined shape includes at least two substantially parallel surfaces. In some embodiments, the particles are fabricated to include geometric asymmetry. In some embodiments, an angle, edge, surface area to volume ratio, curvature of a surface or edge, or the like of the particle may be designed to particular dimensions for particular applications.

In certain embodiments, each particle of a plurality of particles may include an opening. In some embodiments, the particle includes an opening through the particle. An opening may include but is not limited to a channel, hole, aperture, breach or the like. In other embodiments, an opening includes a gap, notch, cavity, well, or the like. In some embodiments, each particle is configured to include an opening having an axis which is substantially parallel to at least one side of the particle. In some embodiments, a particle includes an opening with inner walls that are substantially parallel to the sides of the particle, such as for example, a cylinder-shaped opening. In other embodiments, a particle includes an opening with tapered inner walls, such as for example, a cone-shaped opening.

In some embodiments, each particle includes an opening which is formed in a predetermined shape. The opening may have a cross section of a predetermined shape such as, but is not limited to, a circle, a triangle, a cube, a rectangle, a hexagon, an octagon, a polygon, a parallelogram, a diamond, a crescent, combinations thereof, or the like. In other embodiments, the particle can have multiple openings or channels and each opening or channel can have the same predetermined shape or a variety of predetermined shapes. In some embodiments, the openings or channels can be positioned and engineered to impart flow dynamics to the particle. For example, the channel or channels engineered into the particle can be designed such that the particle flows in a predetermined manner, in response to or only under conditions of a particular flow force, or the like. In some embodiments, the channel(s) of a particular particle can be designed according to the substance in which the particle will be flowing, such as for example, air, water, or the like.

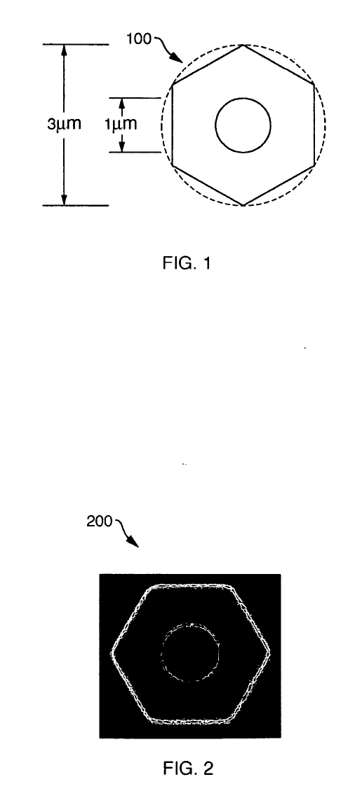

In one embodiment, a particle may have a cross-section of a substantially predetermined shape with an opening fabricated therein. In certain embodiments, a particle may have a cross section in the shape of a hexagon with an opening therein, referred to as a regular hexagonal plate with an opening or a “hex-nut,” as shown in FIG. 1. Particles of some embodiments of the present invention may be fabricated from a mold as described in WO07/024323, WO05/01466, and WO07/030698. Further to the methods disclosed in those references, particles of some embodiments of the present invention may be formed from molds specifically shaped to fabricate particles with opening. A master may be designed and fabricated according to the desired particle shape, including an opening. FIG. 2 shows single hex-nut shaped master 200. A low surface energy polymer, such as a fluoropolymer, PFPE, or FLUOROCUR™ (Liquidia Technologies, Inc.) may be applied to the master and cured, thus forming a replica of the structure of the master, and such replica being able to be used as a mold. In certain embodiments, a mold which is shaped to fabricate particles with an opening may have a solid pillar or pin (or multiple pins if multiple openings in a particle are desired) included in the mold cavity.

In certain embodiments, an opening has a largest dimension of between about 5 percent and about 95 percent of the largest dimension of the particle. In certain embodiments, an opening has a largest dimension of between about 10 percent and about 90 percent of the largest dimension of the particle. In certain embodiments, an opening has a largest dimension of between about 15 percent and about 85 percent of the largest dimension of the particle. In certain embodiments, an opening has a largest dimension of between about 20 percent and about 80 percent of the largest dimension of the particle. In certain embodiments, an opening has a largest dimension of between about 25 percent and about 75 percent of the largest dimension of the particle. In certain embodiments, an opening has a largest dimension of between about 30 percent and about 70 percent of the largest dimension of the particle. In certain embodiments, an opening has a largest dimension of between about 35 percent and about 65 percent of the largest dimension of the particle. In certain embodiments, an opening has a largest dimension of between about 40 percent and about 60 percent of the largest dimension of the particle. In certain embodiments, an opening has a largest dimension of between about 45 percent and about 55 percent of the largest dimension of the particle. In certain embodiments, an opening has a largest dimension of about 50 percent of the largest dimension of the particle.

In some embodiments, the largest dimension of the opening has a dimension of from about 5 microns to about 95 microns. In other embodiments, the largest dimension of the opening has a dimension of from about 10 microns to about 90 microns. In other embodiments, the largest dimension of the opening has a dimension of from about 9 microns to about 81 microns. In other embodiments, the largest dimension of the opening has a dimension of from about 8 microns to about 72 microns. In other embodiments, the largest dimension of the opening has a dimension of from about 7 microns to about 63 microns. In other embodiments, the largest dimension of the opening has a dimension of from about 6 microns to about 54 microns. In other embodiments, the largest dimension of the opening has a dimension of from about 5 microns to about 45 microns. In other embodiments, the largest dimension of the opening has a dimension of from about 4 microns to about 36 microns. In other embodiments, the largest dimension of the opening has a dimension of from about 3 microns to about 27 microns. In other embodiments, the largest dimension of the opening has a dimension of from about 2 microns to about 18 microns. In other embodiments, the largest dimension of the opening has a dimension of from about 1 microns to about 9 microns.

In certain embodiments, an opening has a largest dimension of less than about 90 microns. In other embodiments, an opening has a largest dimension of less than about 80 microns. In other embodiments, an opening has a largest dimension of less than about 70 microns. In other embodiments, an opening has a largest dimension of less than about 60 microns. In other embodiments, an opening has a largest dimension of less than about 50 microns. In other embodiments, an opening has a largest dimension of less than about 40 micron. In other embodiments, an opening has a largest dimension of less than about 30 microns. In other embodiments, an opening has a largest dimension of less than about 20 microns. In other embodiments, an opening has a largest dimension of less than about 10 microns. In other embodiments, an opening has a largest dimension of less than about 9 microns. In other embodiments, an opening has a largest dimension of less than about 8 microns. In other embodiments, an opening has a largest dimension of less than about 7 microns. In other embodiments, an opening has a largest dimension of less than about 6 microns. In other embodiments, an opening has a largest dimension of less than about 5 microns. In other embodiments, an opening has a largest dimension of less than about 4 microns. In other embodiments, an opening has a largest dimension of less than about 3 microns. In other embodiments, an opening has a largest dimension of less than about 2 microns. In other embodiments, an opening has a largest dimension of less than about 1 microns. In other embodiments, an opening has a largest dimension of less than about 950 nanometers. In another embodiment, an opening has a largest dimension of less than about 900 nanometers. In other embodiments, an opening has a largest dimension of less than about 850 nanometers. In another embodiment, an opening has a largest dimension of less than about 800 nanometers. In another embodiment, an opening has a largest dimension of less than about 750 nanometers. In other embodiments, an opening has a largest dimension of less than about 700 nanometers. In another embodiment, an opening has a largest dimension of less than about 650 nanometers. In another embodiment, an opening has a largest dimension of less than about 600 nanometers. In other embodiments, an opening has a largest dimension of less than about 550 nanometers. In another embodiment, an opening has a largest dimension of less than about 500 nanometers. In another embodiment, an opening has a largest dimension of less than about 450 nanometers. In other embodiments, an opening has a largest dimension of less than about 400 nanometers. In another embodiment, an opening has a largest dimension of less than about 350 nanometers. In another embodiment, an opening has a largest dimension of less than about 300 nanometers. In other embodiments, an opening has a largest dimension of less than about 250 nanometers. In another embodiment, an opening has a largest dimension of less than about 200 nanometers. In another embodiment, an opening has a largest dimension of less than about 150 nanometers. In other embodiments, an opening has a largest dimension of less than about 100 nanometers.

In one embodiment, openings in particles are defined by a particle boundary. In one embodiment, the particle boundary and the opening extend from one side of the particle to an opposite side of the particle. In some embodiments, particles having complex boundaries form snow-flake like shaped particles. In one embodiment, particles having an opening with a largest dimension of less than about 100 nanometers have particle boundaries that deform.

Manipulation of Particles

Functionalization

In some embodiments, the particles of the present invention include a functional additive. The functional additive can include, but is not limited to, paramagnetic or superparamagnetic materials, ions to yield particles with dipole moment, chemical functionality to yield particles with binding energy or are capable of undergoing a chemical reaction or intermolecular bonding (e.g., hydrogen bonding), a doping agent, surface characteristics, surface tension, geometric properties that functionalize the particle, intrinsic properties, charges on the edge or surface(s) of the particle, charges near the edge of the particle, combinations thereof, or the like. In certain embodiments, magnetic additives are of an organic material containing an amount of ferromagnetic substance such as iron based oxides, e.g. magnetite, transition metals, or rare earth elements, which causes them to be captured by a magnetic field.

In some embodiments, the particle can be functionalized while the particle remains in the mold. In other embodiments, the particle can be functionalized while in the mold but before solidification of the particle precursor matrix. In yet other embodiments, the particle can be functionalized while still in the mold but after solidification of the particle precursor matrix. In still further embodiments, the particles can be functionalized after the particles are transferred from the mold to a substrate where the relationship of particles with respect to adjacent particles remains unchanged. According to other embodiments, the particle may be fabricated in any shape and functionalized to impart desired properties to the particle. In some embodiments, the functional properties of the particle can be localized to predetermined or selected regions of the particle, such that the particle has regiospecific functionalization. In some embodiments, functionalization can include metallization, chemical reaction with the surface, adsorption to the surface, and the like.

In certain embodiments, particles may include functional additives which cause the particle to respond to a magnetic field. In one embodiment, particles may be doped with magnetite to demonstrate a response to an externally applied magnetic field. In a specific embodiment, paramagnetic magnetite nanoparticles are dispersed in photopolymerizable monofunctional polymerizable monomers, such as neat hydroxyethylmethacrylate (HEMA) to form a polymerizable suspension. In certain embodiments, the polymerizable suspension is combined with free-radically curable crosslinkers, such as trimethylol propane ethoxylate triacrylate (PEG-triacrylate) and used to fill the cavities in the mold. Upon curing, robust, cross linked magnetite particles may be produced. A variety of particle shapes may be doped and formed according to this embodiment, including but not limited to hex-nut, boomerang, and rectangular column particles. The doped particles may respond to externally-applied magnetic fields and in some embodiments, assemble according to the applied force into larger structures.

In one embodiment, particles may be fabricated to demonstrate chirality. Triangles having 30-60-90 degree angles are two-dimensional chiral objects. In some embodiments, particles can be fabricated with a cross section having the shape of a chiral 30-60-90 degree angle triangle. In a specific embodiment, particles are fabricated in chiral 30-60-90 degree angle triangles and an exposed face or surface of the triangle particle is functionalized, imparting a chirality to the triangle particle. In some embodiments, a functionalized surface of a 30-60-90 degree angle triangle can create chro-optical properties of colloidal liquids.

Positioning within Particle

In certain embodiments, a functional additive may be selectively positioned in a desired portion of the particle. In some embodiments, the functional additive is manipulated to a predetermined or desired position within the particle precursor, prior to curing or hardening, such that the functional additive is not in a thermodynamically stable position or in a metastable condition. In some embodiments, the functional additive is manipulated to a predetermined or desired position within the particle by the application of an external field prior to or during the particle precursor being cured or hardened. According to some embodiments, as will be described in more detail below, the particle is formed from a flowable substance, such as for example a liquid or a powder. When the particle precursor is in this flowable condition and maintained in a mold, a force can be applied that manipulates the functional additive to the non-thermodynamically stable or metastable position within the particle precursor. Then, when the particle precursor is hardened or solidified, the functional additive is locked into this non-thermodynamically stable position.

In certain embodiments, once the functional additives are located in a desired position of the particle precursor, a treatment can be applied to the particle precursor to lock the functional additives in the desired position. Treatment can be, for example, heating, evaporation, UV radiation, photo-curing, cooling, combinations thereof, or the like to harden, solidify, or cure particle precursor into particle.

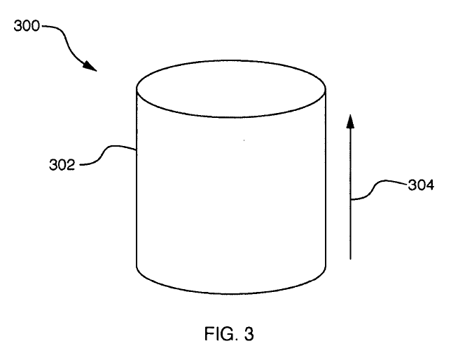

Referring to FIG. 3, a particle 300 is shown released from a low surface energy mold that it was fabricated in. Particle 300 is shown in a cylindrical shape, however, it will be appreciated that the three dimensional shape of particle 300 can represent any shape that corresponds to the mold from which particle 300 was fabricated in. In certain embodiments, particle 300 also includes functional additives 302. Functional additives 302 can be, for example, ions, magnetic material, chemical functionality such as available bonding sites, surface tension, a doping agent, combinations thereof, or the like. In an embodiment, during fabrication of particle 300, a force, as defined herein, can be applied to the particle precursor matrix such that functional additive 302 orientates within particle 300 in a predetermined position. According to an embodiment, following fabrication of particle 300, the functional additive 302 gives particle 300 an active orientation that responds to a force represented by arrow 304. It should be appreciated that the active orientation of the particle will respond to different forces depending on the type of functional additive used, e.g., particles having magnetic doping agents will take an active orientation in response to an applied magnetic force whereas particles having ionic doping agents will respond to an electric field and the like.

In some embodiments, the particles are fabricated to include compositional asymmetry. In some embodiments, compositional asymmetry can be imparted to the particles by applying an alignment field to the liquid particle precursor matrix filled in the mold prior to “solidification” of the particle. According to some embodiments, the functional additive will diffuse into the particle tip, side, bottom, top, circumference, perimeter, center, combinations thereof, or the like, and become locked in a desired position within the particle by curing or solidifying the liquid particle precursor matrix. In some embodiments, diffusion or migration of the functional additive within the particle precursor matrix can be manipulated, enhanced, or encouraged by application of a force or energy, such as for example, magnetic, electric, ionic, centrifugal, gravitational, heat, pressure, chemical functionality such as active binding sites, combinations thereof, or the like. According to other embodiments, the functional additive can be introduced to the mold prior to introducing the particle precursor matrix to the mold.

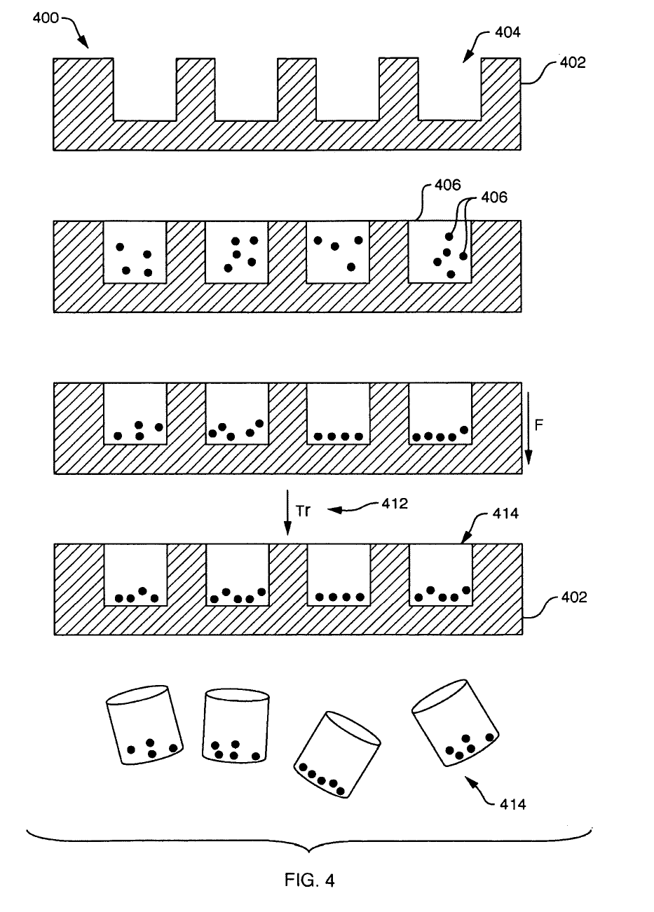

FIG. 4 shows the fabrication 400 of particles that include a functional additive in a non-thermodynamic equilibrium or metastable state. Initially, a mold 402 is provided that includes wells 404. Preferably the mold is fabricated from a low surface energy polymeric material, such as but not limited to a fluoropolymer, perfluoropolyether, or FLUOROCUR™ (Liquidia Technologies, Inc.). The wells 404 are shaped according to a desired predetermined particle shape. Next, particle precursor 406 is introduced into wells 404. Particle precursor can be a liquid material, powdered material, or otherwise flowable material that can enter wells 404. Particle precursor 406 can include functional additive 408, or in alternative embodiments, functional additive 408 can be added to particle precursor 406 after particle precursor 406 is introduced into wells 404. Next, a force 410, as defined herein, is applied to the combination of the particle precursor 406, functional additive 408, and mold 402. Force 410 is selected as a force that is appropriate to interact with functional additive 408 and position functional additive 408 into a desired location or orientation within particle precursor 406. Force 410 is capable of manipulating functional additive 408 accordingly because particle precursor 406 is a flowable or semi-flowable material, such as for example a liquid or a powder. Force 410 remains applied to the combination of particle precursor 406, mold 402, and functional additive 408 to maintain the predetermined positioning of functional additive 408 while a treatment 412 is applied to the combination. Treatment 412 can be, for example, heating, evaporation, UV radiation, photo-curing, cooling, combinations thereof, or the like to harden, solidify, or cure particle precursor 406 into particle 414. After treatment 412 has solidified or hardened particle precursor 406 into particle 414, force 410 can be removed and functional additive 408 remains in its predetermined position. Following treatment 412, particles 414 can be removed from mold 402. Removal of particles 414 from mold 402 is further described in the patent applications incorporated herein by reference.

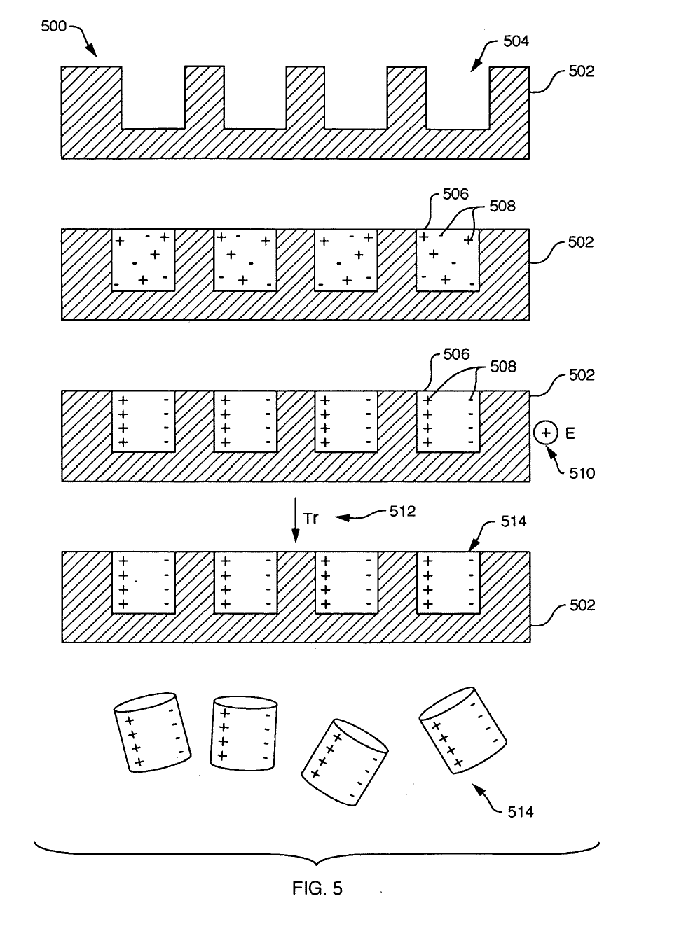

FIG. 5 shows another process for fabricating particles with functionality according to yet another embodiment of the present invention. According to FIG. 5, a mold 502 is provided that includes wells or recesses 504. Preferably the mold is fabricated from a low surface energy polymeric material, such as but not limited to a fluoropolymer, perfluoropolyether, or FLUOROCUR™. Wells 504 are shaped according to a desired predetermined particle shape. Next, particle precursor 506 is introduced into wells 504. Particle precursor can be a liquid material, powdered material, or otherwise flowable material that can enter wells 504. Particle precursor 506 can include functional additive 508, such as charged particles or molecules. In alternative embodiments, functional additive 508 can be added to particle precursor 506 after particle precursor 506 is introduced into wells 504. Next, a force 510, as defined herein such as a field is applied to the combination of the particle precursor 506, functional additive 508, and mold 502. Force 510 manipulates functional additive 508 into a predetermined position within particle precursor 506 because particle precursor is a flowable or semi-flowable material, such as for example a liquid or a powder. Force 510 remains applied to the combination to maintain the predetermined positioning of functional additive 508 while a treatment 512 is applied to the combination. Treatment 512 can be, for example, heating, evaporation, UV radiation, photo-curing, cooling, combinations thereof, or the like to harden, solidify, or cure particle precursor 506 into particle 514. After treatment 512 has solidified or hardened particle precursor 506 into particle 514, force 510 can be removed and functional additive 508 remains in its predetermined position. Following treatment 512, particles 514 can be removed from mold 502, as described elsewhere in this application.

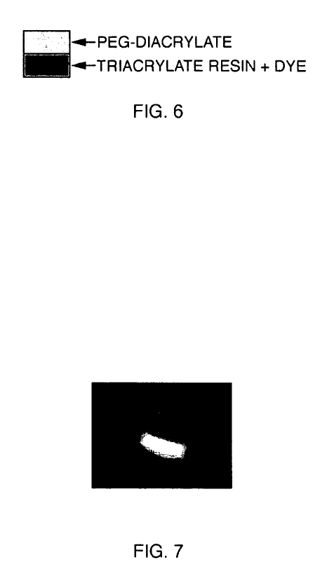

Referring to FIGS. 6 and 7, in an effort to explore chemically-directed assembly of particles, Janus type particles have been fabricated that have one hydrophobic face and one hydrophilic face. In some embodiments, these particles can be fabricated from a 7 micron diameter×7 micron deep mold made from, but not limited to, FLUOROCUR™. In some embodiments, the mold can be partially filled with, for example, fluorescently doped trimethylol propane triacrylate (triacrylate resin) and cured to produce a hydrophobic segment, where the fluorescent dye can be used for visualization purposes. The remainder of the mold cavity can then be filled with, for example, poly(ethylene glycol)₄₀₀ diacrylate (PEG diacrylate) and cured to produce a hydrophilic segment. The particle and its segments are illustrated in FIG. 6. Fluorescence micrography in FIG. 7 shows the hydrohobic segment is substantially confined to one segment of the particle. In some embodiments, when a combination hydrophilic hydrophobic particle is subjected to a selective environment (e.g., hydrophilic or hydrophobic), the particles assemble in a predictable and controlled manner. For example, combination hydrophilic hydrophobic particles, when introduced to a hydrophobic environment will assemble such that the hydrophilic regions attract, thereby leaving the hydrophobic region associated with the similar hydrophobic environment. Moreover, the hydrophilic regions tend to prevent continued assembly of structures beyond pairs, or can be added after a predetermined term of assembly to terminate self assembly.

Forces to Manipulate Particles

In some embodiments, the functional additive causes the particle to be sensitive to applied forces and react in a controlled manner. In certain embodiments, the functional additives include but are not limited to magnetic material, charged material, thermally reactive material, chemically reactive material, electrically reactive material, radiation sensitive material, surface energy, hydrophibic or hydrophilic materials, combinations thereof, and the like. Forces may include but are not limited to a magnetic force, a thermal force, an electric force, a chemical force, a biologic signal, a photonic signal, radiation, a mechanical force, a physical force, combinations thereof, and the like.

According to some embodiments, the particles with functional additives can be molded according to the present methods and materials to yield particles of precise predetermined shapes and sizes. These modified particles can then be subjected to external forces, such as for example, magnetic, thermal, electric, chemical, biologic signal, photonic signal, radiation, mechanical, physical, ion, and the like to manipulate the particles.

According to some embodiments, particles fabricated according to the present invention can be manipulated consistently with their functional additive, dopant and/or geometry. In some embodiments, alignment fields and alignment forces can be, but are not limited to, sheer flow of a fluid, stacking, or bridging, electric field, magnetic field, chemical functionality, electro-osmotic flow through charge separation, electrophoresis, surface tension, surface tension of soap or surfactant films, temperature, physical properties such as hydrophobia, solubility, polarity, combinations thereof, or the like.

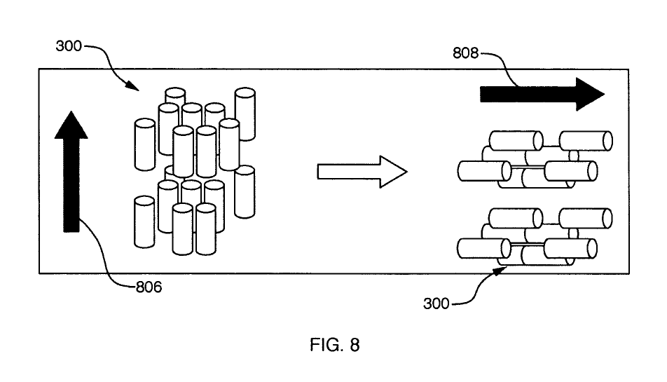

Particles with functional additives may respond to an external force by orienting or aligning in a controlled manner. Referring now to FIG. 8, multiple particles 300 are shown on the left of the figure. The particles 300 on the left of the figure respond to force 306, as defined herein, and orient in a vertical orientation. However, when a second force, e.g., force 808 oriented in a second direction, is applied to particles 300 the particles 300 react and orient or assemble accordingly. For example, as shown on the right side of FIG. 8, particles 300 orient in a horizontal direction in response to force 808.

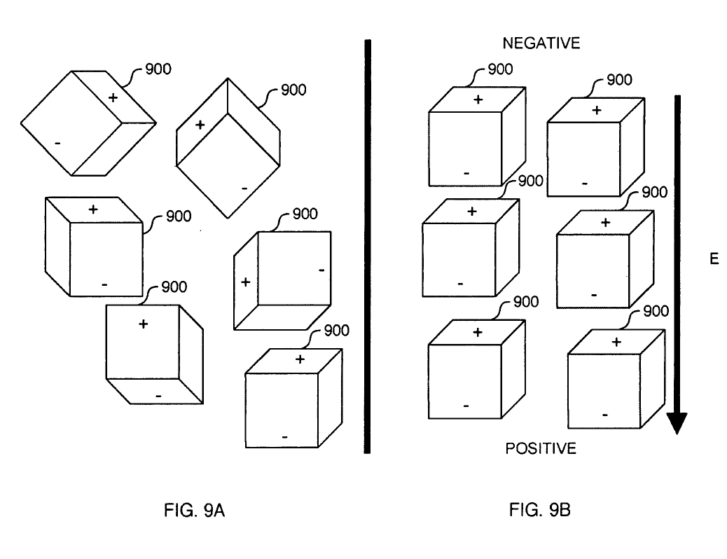

Referring now to FIGS. 9A and 9B, FIG. 9A shows particles 900 released from the mold in which they were fabricated. Particles 900 include a functional additive that provides particle 900 with a polarity and makes particle 900 responsive to an electric field or force, as defined herein. Accordingly, as an electric field or force E is applied to particles 900, particles 900 arrange themselves in an ordered format, as shown in FIG. 9B. Utilizing electric field or force E, particles 900 can be manipulated to arrange into a predetermined structure or give off a desirable property or effect.

Structures Formed from Self or Directed Assembly of Particles

In certain embodiments, particles may be assembled to form a structure. In some embodiments, the particles assemble based on their shape. In other embodiments, a plurality of particles, each including a functional additive, are subjected to a force and assemble based on the applied force and/or the position, orientation, type, or lack of functional additive. According to some embodiments, three dimensional structures such as, for example, laminates, crystalline structures, spheres, planes, rods, patterned arrays, photonic chips, optical devices, opto-electronic devices, semiconductors, planarized highly compact functional micro-optical circuits, tools, combinations thereof, and the like can be fabricated from particles. In some embodiments the particles include functional additives.

According to yet other embodiments, the particles of the present invention can be manipulated to form, for example, tessellation of a plane, orthogonal concatenation of elements, ordered formation, fractal formation, combinations thereof, or the like. In some embodiments, the particles of the present invention can be assembled by other assembly techniques, include doping agents, geometry, methods, materials, and processes, to include and form structures as described in U.S. Pat. No. 6,884,478; 6,855,202; 6,468,811; and 6,033,547; U.S. Published application no. 2005/0047575; 2004/0053009; and 2004/0050435; and the publication by Yeh, Seul, Shraiman “Assembly of ordered colloidal aggregates by electric field induced fluid flow” Nature, 386, 57-59 (1997); each of which is incorporated herein by reference in its entirety including all references cited therein.

According to some embodiments, the particles with functional additives can be molded according to the present methods and materials to yield particles of precise predetermined shapes and sizes. These modified particles can then be subjected to external forces, such as for example, magnetic, electric, chemical, ion, and the like to align and organize into three dimensional structures and devices. According to some embodiments, the modified particles of the present invention do not include functional additives and yet still arrange and organize themselves into three dimensional structures and devices due to their shape or geometry, surface characteristics, sheer flow, stacking, combinations thereof, and the like. In some embodiments, functional additives are selectively positioned in a portion of each particle.

A structure may be formed from the assembly of a plurality of particles, where each particle of the plurality of particles has a cross section of a predetermined shape. In certain embodiments, the predetermined shape of the cross section may be a circle, a triangle, a cube, a rectangle, a hexagon, a hexagon with an opening, an octagon, a polygon, a parallelogram, a diamond, a crescent, combinations thereof, or the like.

The particles may assemble to form a macrostructure, a microstructure, or a nanostructure. In certain embodiments, the structure is magnetically, electromagnetically, electrically reactive, or the like. Such a structure may be formed from a plurality of particles, where each particle includes a magnetic, electromagnetic, or electrically sensitive portion.

In other embodiments, the structure is chemically reactive. Such a structure may be formed from a plurality of particles, where each particle includes a chemically sensitive portion.

In some embodiments, the structure is physically reactive. According to such embodiments, a physical force, such as agitation, impact, gravitational, or the like forces can cause the particles to assemble into or disassemble from an assembled structure.

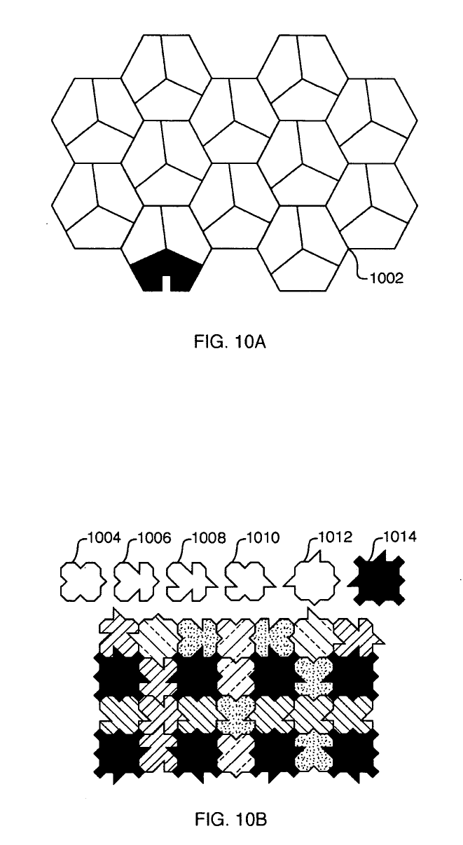

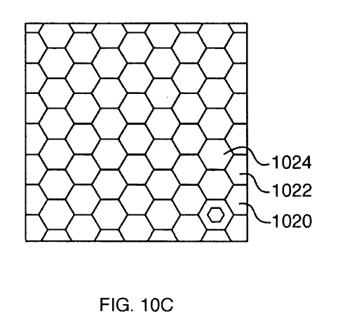

In some embodiments, a plurality of particles may form a plane. Referring now to FIGS. 10A-10C, particles are tessellated into larger plane structures according to embodiments of the present invention. According to FIG. 10A, particles 1002 are aligned with similar particles to form a plane structure. Referring now to FIG. 10B, particles 1004, 1006, 1008, 1010, 1012, and 1014 are shown self assembled into a plane structure. Referring to FIG. 10C, particles 1020, 1022, and 1024 are shown self-assembled into a plane structure.

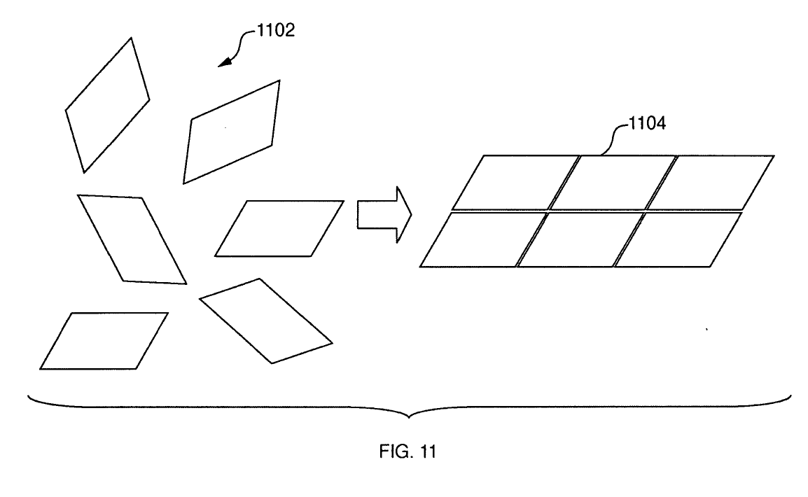

Referring now to FIG. 11, particles 1102 are shown as separate particles on the left side of the figure. A force, represented by the arrow and as defined herein, can be applied to particles 1102 and particles 1102 arrange into a sheet like formation 304, as shown on the right side of the figure.

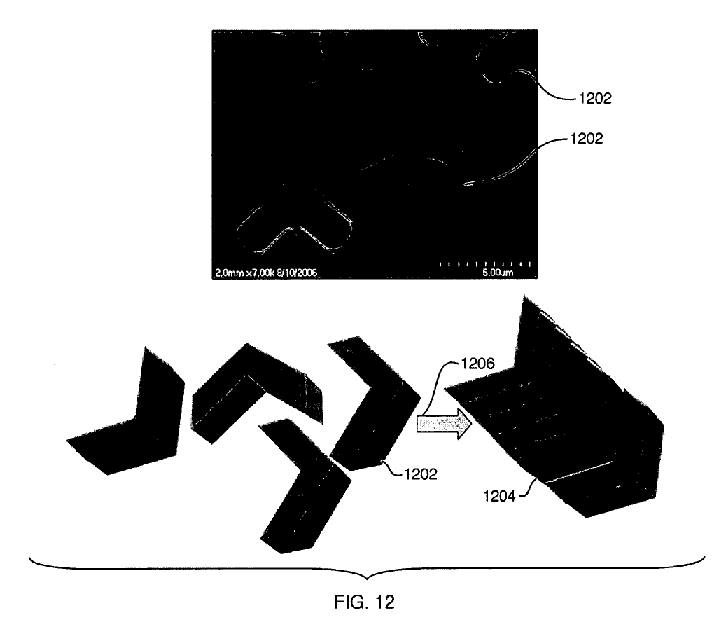

FIG. 12 shows particles 1202 fabricated according to an embodiment of the present invention. According to an embodiment of the present invention, a force 1206 can be applied to the particles 1202 and thereby cause the particles to arrange into a self-assembled structure 404.

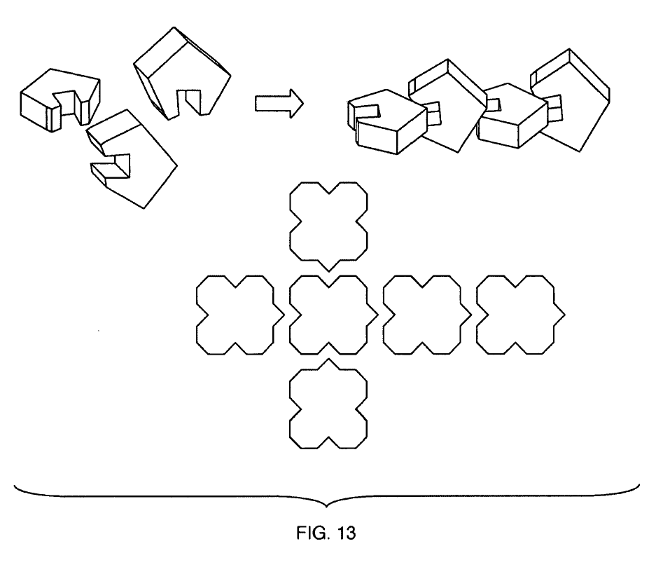

FIG. 13 shows yet further embodiments of particles fabricated according to methods and materials of the present invention. The particles of FIG. 13 are also shown undergoing concatenation to form a structure. FIG. 14 shows structures formed from fractal particles according to embodiments of the present invention.

Assembly of particles may be driven by shape, chemical forces, magnetic force, thermal force, electric force, biologic signal, a photonic signal, radiation, mechanical force, physical force, combinations thereof, and the like.

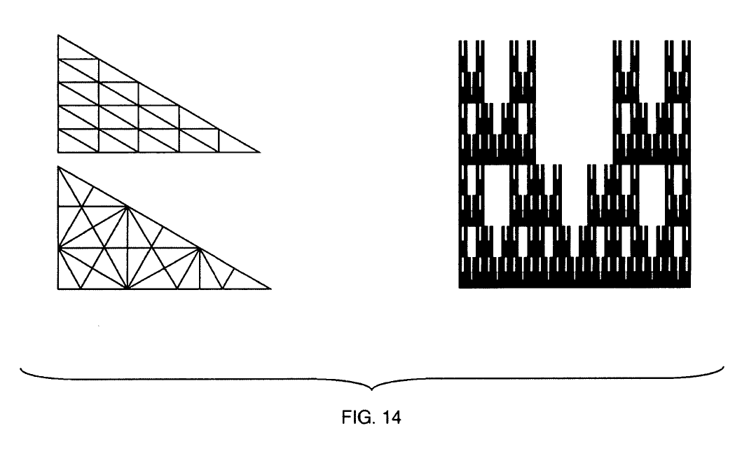

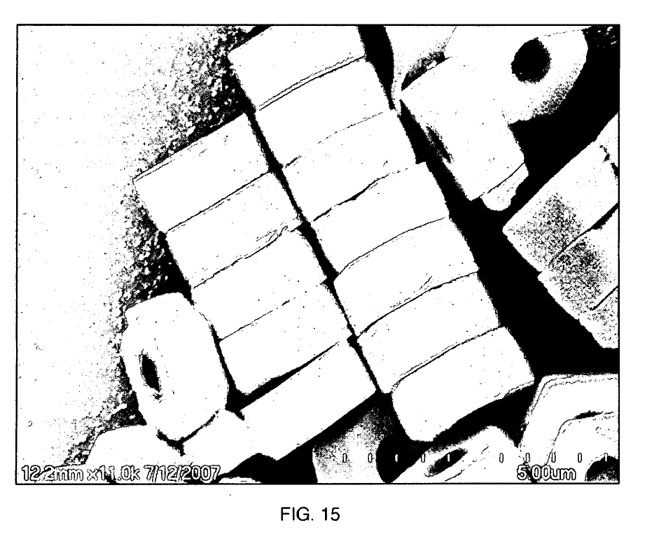

In some embodiments, a plurality of particles form a structure based on shape-specific assembly. In certain embodiments, particles are fabricated to demonstrate both shape-specific positioning and shape-specific orientation. Referring to FIG. 15, the disc-shaped hex-nut particles form rod-like assemblies due to face-to-face stacking when allowed to assemble from an aqueous suspension. Additional orientation-specific assembly is observed due to the alignment of faces and corners of the hex-nut particles. In some embodiments, such ordering behavior is demonstrated when glass coupons are slowly withdrawn from solution. In other embodiments, such ordering behavior occurs when the particle suspension are dried on a glass substrate. In some embodiments, particles fabricated to demonstrate shape-driven, direct orientational alignment may form function self-assembled devices, for example, devices where individual components of the device will need to be have both precise positioning and orientation.

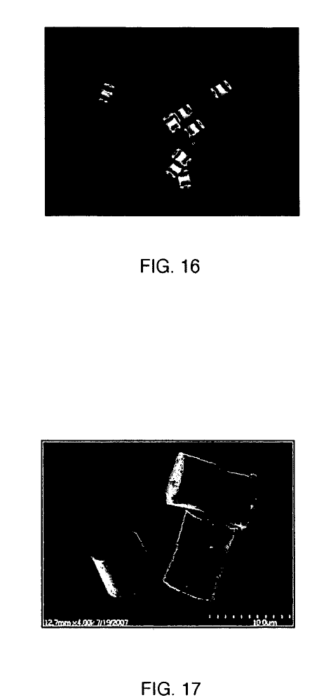

In some embodiments, a plurality of particles form a structure based on chemically-directed assembly. Referring to FIGS. 16 and 17, particles were fabricated with one hydrophilic and one hydrophobic face. In this embodiment, the hydrophobic triacrylate resin portion of the particle is doped with a fluorescent dye as shown in FIG. 16. Assembly of these particles in acetone may show controlled dimerization of the particles, based on specific self-assembly of the hydrophobic faces, as shown in FIG. 17. In some embodiments, the hydrophilic faces prevent continued assembly of particles in the self-assembled structures beyond two particles. In some embodiments, such self-directing, self-terminating particle assembly may be suitable for precise assembly of mesoscale functional devices. In certain embodiments, chemically-directed assembly may be synergistic with the shape-directed orientational assembly described above. In certain embodiments, chemically-directed and shape-directed assembly techniques may be combined to produce self-assembled mesoscale structures with precisely positioned and oriented parts.

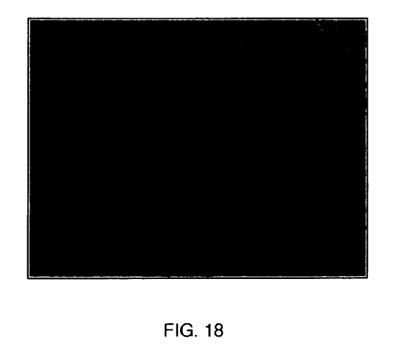

In some embodiments, a plurality of particles may be assembled on a two-dimensional liquid film substrate. Referring to FIG. 18, hex-nut and cubic particles may be deposited onto a liquid film including perfluoropolyether-diol and allowed to assemble under vortex and magnetic field. In other embodiments, suitable liquids for the liquid film may include water, 1,1,1,3,3-pentafluorobutane, perfluorodecalin, and perfluoropolyether-diol. FIG. 18 shows that the particles assembled into small areas of close-packed hex-nut particles, although no long-range ordering was observed. In some embodiments, the particles respond to a magnetic field. In certain embodiments, for example, particles containing magnetic particles in a circular sample cell floating on a liquid film may move toward the high-magnetic field strength region at the center of the cell when the end of a bar magnet is placed under the center of sample cell. In another embodiment, particles may migrate toward the edge of the sample cell, again toward regions of higher magnetic strength, when an annular magnet is used. In certain embodiments, application of these external magnetic fields did not appear to have much impact on the assembly of the plurality of particles.

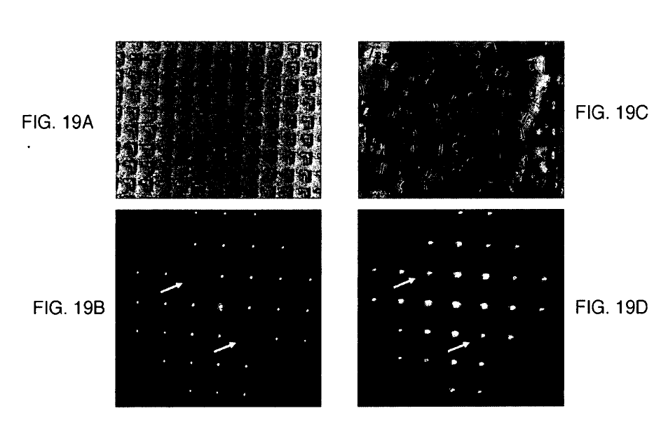

In some embodiments, a plurality of particles is assembled by a harvesting layer template technique. Referring to FIG. 19A-D, boomerang-shaped particles were harvested on a HEMA harvesting substrate. In the ordered, “as harvested” state seen in FIG. 19A, boomerang particles are preferentially oriented, thereby causing a unique diffraction pattern that is “missing” two diffraction spots as seen in FIG. 19B, when compared to an array of cylindrically symmetric particles. When the HEMA harvesting layer is swelled in IPA, however, particles may become free to rotate (while remaining in a periodic array), as seen in FIG. 19C resulting in the appearance of the diffraction spots that were originally “missing,” as seen in FIG. 19D. This dynamic photonic behavior of the system may be a result of the unique optical properties of boomerang particle arrays, and may be useful in such applications as optical communications, modulators and demodulators, hollography, gradings, and optical fibers.

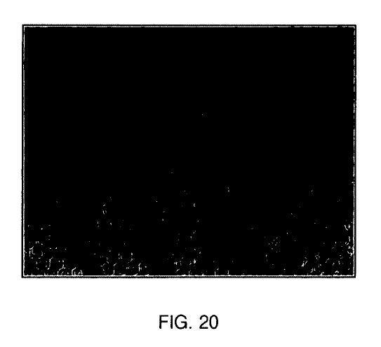

Referring to FIG. 20, a harvesting layer may be used as a template for the formation of close-packed hex-nut particles. Hex-nut particles may be harvested onto a HEMA film. The film may then be swelled in IPA for 30 seconds or water for 10 minutes. As shown in FIG. 20, regions of close-packed hex-nuts may be produced. This self-assembled structure is quite different from the face-to-face packing that is observed when hex-nuts are assembled from a suspension, as shown in FIG. 15. In some embodiments, the initial state of particles in an array may be critical to enable the formation of such a two-dimensional self-assembled structure as shown in FIG. 20.

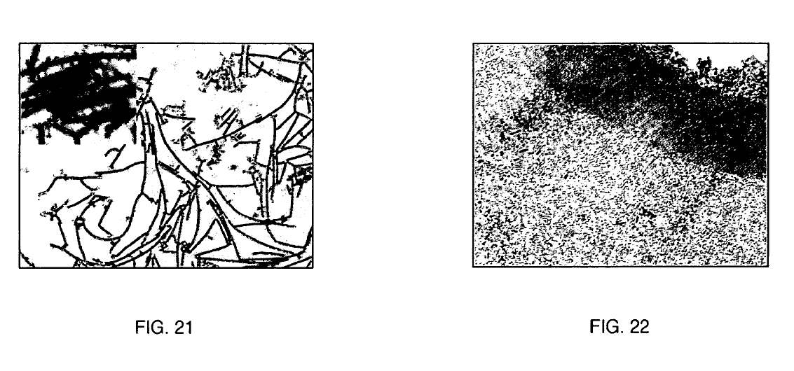

In some embodiments, the concentration of the particles in a suspension is related to the type of structure formed by the particles. As shown in FIG. 21, dilute suspensions of rectangular column particles show end-to-end assembly. More concentrated suspensions that were prepared from a harvested array, shown in FIG. 22, show distinct phases such as out-of-plane hexagonal packing (upper right corner) and in plane, quasi-ordered packing (lower left).

Once a structure is assembled, the plurality of particles may be disarranged. In some embodiments, the plurality of particles are disarranged by removing the force which caused the plurality of particles to arrange to form the structure. In other embodiments, the plurality of particles are disarranged by subjecting the structure to a second force. In certain embodiments, disarranging the plurality of particles results in partial disassembly of the structure. In some embodiments, disarranging the plurality of particles results in substantial or total disassembly of the structure.

Changeable Parameter

In some embodiments, a parameter or parameters of the structure can be altered or changed by manipulating the assembly of particles that formed the structure. In some embodiments, a structure can be formed by assembly of functionalized or un-functionalized particles as described herein. After the structure is formed, a force, as defined herein, can be applied to that structure to manipulate the particles of the structure and change a parameter of that structure.

For example, nano or micron sized particles can be assembled into a plane to form a transparent layer of material. The nano or micron sized particles can be doped with a functional additive such that the particles respond to a particular applied force, such as described herein. After the transparent layer structure is formed, a force can be applied to manipulate the orientation of the nano or micro particles, which can then cause the transparent parameter of the layer to become translucent, opaque, or reflective.

In other embodiments, the changeable parameter of the structure can include, but is not limited to, an optical, physical, chemical, or electrical parameter of the structure. In some embodiments, the changeable parameter includes refractive index, reflectiveness, diffraction, color, transmission, translucence, opaqueness, combinations thereof, or the like. In other embodiments, the changeable parameter includes hardness, toughness, strength, elasticity, density, surface energy, roughness, charge, electric field, hydrophilicity, hydrophobicity, magnetic field, combinations thereof, or the like. In certain embodiments, the stimulus or force for inducing the parameter to change can be, but is not limited to magnetic, electromagnetic, electrical, chemical, physical, optical, combinations thereof, or the like.

### Examples

### Example 1

### Formation of Assembled Microparticles

A UV curable elastomer mold was prepared with 5×5×10 micron cavities, according to the teachings of PCT International Patent Application Serial No. PCT/US04/42706, filed Dec. 20, 2004 and other pending applications that are incorporated herein by reference.

A 1 inch by 1 inch square was cut from the elastomer mold and placed pattern side up. Separately, 1.6 g of trimethylol propane triacrylate (TMPTA, Aldrich) was thoroughly mixed in a vial with 0.2 g of diethoxyacetophenone photoinitiator (DEAP, Aldrich). A drop of approximately 5 mm of the TMPTA/DEAP mixture was placed on the patterned side of the elastomer mold, using an eye dropper. A polyethylene film was placed over the drop to evenly spread it across the patterned side of the elastomer mold. The polyethylene film was slowly peeled away from the patterned surface of the elastomer mold. Excess TMPTA/DEAP mixture was removed from the surface with a paper wipe. The elastomer mold was placed into a UV photopolymerization chamber and the atmosphere was purged with a steady stream of nitrogen gas for 2 minutes. UV irradiation (λ=365 nm, Electrolite 4001 UV lamp) was then used to photopolymerize the TMPTA/DEAP mixture in the cavities of the elastomer mold.

Separately, 2 g of 1-vinyl-2-pyrrolidinone (VP) was mixed in a vial with 0.04 g of hydroxycyclohexylphenyl ketone (HCPK) until clear. Approximately 0.1 mL of this mixture was placed on a glass microscope slide. The elastomer mold filled with polymerized TMPTA was placed, pattern side down, onto the liquid drop of the VP/HCPK mixture on the slide. This microscope slide was placed into a sealed UV photopolymerization chamber and the atmosphere was purged with a steady stream of nitrogen gas for 2 minutes. UV irradiation (λ=365 nm, Electrolite 4001 UV lamp) was then used to photopolymerize the VP monomer.

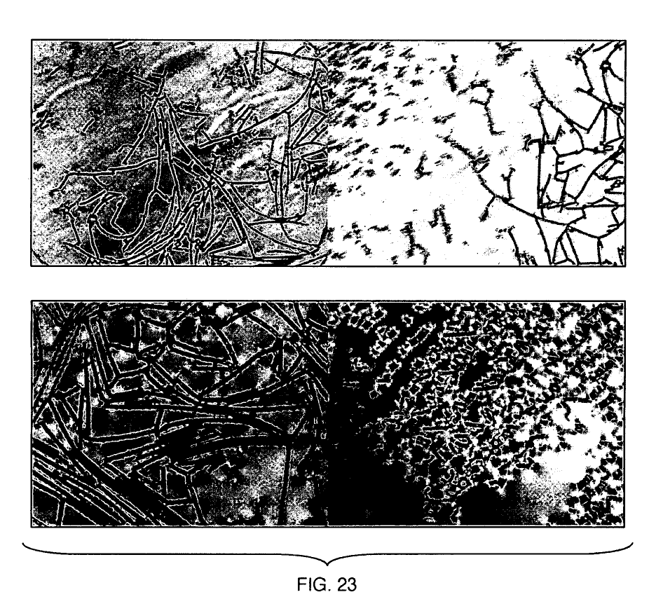

The elastomer mold was slowly peeled away from the polymerized VP monomer layer, resulting in transfer of the polymerized TMPTA particles from the mold to the polymerized VP layer. A drop of water approximately 5 mm in diameter was applied to the polymerized VP surface. TMPTA particles were observed to release from the surface in contact with the water drop and form assembled structures as shown in FIG. 23.

### Example 2

### Representative Procedure for Iron (II,III) Oxide Synthesis and Stabilization in HEMA/Particle Formulations

Iron (II,III) oxide (magnetite) was prepared and stabilized in water according to the following procedure. A three neck flask was charged with iron (II) chloride (98%, Aldrich Chemical Company, Milwaukee, Wis., United States of America) (1.545 g, 12.2 mmol), iron (III) chloride hexahydrate (97%, Aldrich) (4.24 g, 15.7 mmol), and 50 mL of 0.12 M hydrochloric acid solution (37 %, Aldrich) and placed under an inert atmosphere with mechanical stirring. After 15 minutes, 1.5 M sodium hydroxide solution was added slowly under continuous stirring and sonication until a pH of 12.0 was reached. A strong magnet was then used to pull the magnetite out of suspension and the basic solution was decanted. The magnetite was then washed with distilled water at least twice until a pH of 10.5 was reached. 1 M HCl was then added until a pH of 9 was obtained followed by two ethanol washes. Distilled water was then added and the mixture was sonicated to achieve a stabilized suspension of magnetite particles (ferrofluid).

In a representative magnetite-stabilized particle formulation, magnetite (90% w/w in water), 2-hydroxyethylmethacrylate (HEMA, 99+%, Aldrich), trimethylolpropane ethoxylate triacrylate (PEG-TA, Aldrich) in a ratio of 1:2:1 (w/w), respectively, were combined along with 0.1% (w/w) 2,2-diethoxyacetophenone (95%, Aldrich) and sonicated to obtain a brown photocurable ferrofluid. Magnetite is stabilized via hydrogen bonding; therefore, HEMA can be utilized as a hydrogen donor to promote its stabilization and suspension. This particular formulation (25% magnetite) requires nearly twice as much HEMA as PEG-TA to prevent magnetite agglomeration as shown in the table below. Incorporation of up to 10% (w/w) of [2-(acryloyloxy)ethyl]-trimethylammonium chloride (AETMAC, 80 wt. % solution in water, Aldrich) was also possible without the agglomeration of magnetite to develop a positively charged formulation.

TABLE 1

| Mixture | Ratio (%) | Agglomeration |
|---|---|---|
| Magnetite:HEMA | 50:50 | No |
| Magnetite:HEMA:PEG-TA | 10:40:60 | No |
| Magnetite:HEMA:PEG-TA | 25:50:50 | Yes |
| Magnetite:HEMA:PEG-TA | 25:50:25 | No |

### Example 3

### Representative Procedure for Encapsulation of Magnetite into HEMA/PEG-TA Particles

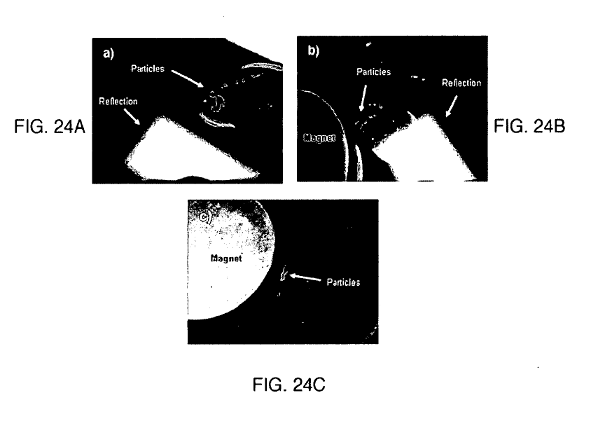

A patterned perfluoropolyether (PFPE) mold was generated by pouring a PFPE-dimethacrylate (PFPE-DMA) containing 2,2-diethoxyacetophenone (DEAP, 95%, Aldrich) over silicon substrates patterned with 3 μm hex-nuts and 20 μm boomerangs. The mold was then subjected to UV light (λ=365 nm) for 2 minutes while under a nitrogen purge. The fully cured PFPE mold was then released from the silicon master. A drop of the magnetite/HEMA/PEG-TA formulation (25:50:25 w/w) described above was then placed on the PFPE mold and manually filled and covered with a glass slide. Due to the rapid evaporation of HEMA from the mold, a second fill with PEG-TA and 0.1% DEAP was required to fill any remaining voids in the mold cavities and provide full particles. Without a second PEG-TA fill, only pieces of particles were harvested. Sequential fills with the magnetite formulation, as well as, filling on top of a magnet were both done to increase the concentration of magnetite in the particles. All particles elicited a response in the presence of an external magnetic field with particle size having an effect on the response-larger particles responded more rapidly. FIGS. 24A-C show the particles gathering at the locations of the magnet. The positively charged formulations with AETMAC present lead to charged particles that gave stable dispersions in water and after removing the external magnetic field; whereas, some particles remain aggregated after exposure to the magnetic field.

Each reference identified herein is hereby incorporated by reference as if set forth in its entirety.

We claim:

1. A plurality of nanoparticles, comprising:
a plurality of particles wherein each particle of the plurality of particles is configured with a substantially predetermined shape and a largest dimension less than about 100 micrometers, and wherein each particle of the plurality of particles includes an opening through the particle.

2. The nanoparticles of claim 1, wherein the substantially predetermined shape comprises at least two substantially parallel surfaces.

3. The nanoparticle of claim 1, wherein the opening comprises a diameter of between about 10 percent and about 90 percent of the largest dimension of the particle.

4. The nanoparticle of claim 1, wherein the opening comprises a predetermined shape.

5. A method of assembling a structure, comprising:
subjecting a plurality of particles to a force to arrange the plurality of particles with respect to each other to form a structure
wherein each particle of the plurality of particles comprises a predetermined shape, a largest dimension less than about 10 micrometers, and a functional additive.

6. The method of claim 5, further comprising, before subjecting the plurality of particles to a force, forming the plurality of particles such that the functional additive is selectively positioned in a portion of the particles.

7. The method of claim 5, further comprising removing the force or subjecting the structure to a second force such that the plurality of particles disarrange.

8. The method of claim 5, wherein:
the force is selected from the group consisting of a magnetic force, a thermal force, an electric force, a chemical force, a biologic signal, a photonic signal, radiation, a mechanical force, and a physical force.

9. The method of claim 5, wherein:
the functional additive is selected from the group consisting of magnetic material, thermally reactive material, chemically reactive material, electrically reactive material, radiation sensitive material, and surface energy.

10. A magnetically, electromagnetically, or electrically reactive structure, comprising:
a plurality of particles, wherein each particle of the plurality of particles is configured with a substantially predetermined shape, a largest dimension less than about 100 micrometers, and a magnetic, electromagnetic, or electrically sensitive portion; and
wherein a structure includes a predetermined arrangement of the plurality of particles and a changeable parameter of the structure is configured to change in response to a magnetic, electromagnetic, or electrical stimulus.

11. The structure of claim 10, wherein the changeable parameter of the structure includes an optical, physical, chemical, or electrical parameter of the structure.

12. The structure of claim 10, wherein the changeable parameter is selected from the group consisting of refractive index, reflectiveness, diffraction, color, transmission, translucence, and opaqueness.

13. The structure of claim 10, wherein the changeable parameter is selected from the group consisting of hardness, toughness, strength, elasticity, density, surface energy, roughness, charge, electric field, hydrophilicity, hydrophobicity, and magnetic field.

14. The structure of claim 10, wherein each particle of the plurality of particles has a cross section, and the predetermined shape of the cross section of each particle of the plurality of particles is selected from the group consisting of a circle, a triangle, a cube, a rectangle, a hexagon, an octagon, a polygon, a parallelogram, a diamond, and a crescent.

15. A chemically reactive structure, comprising:
a plurality of particles, wherein each particle of the plurality of particles is configured with a substantially predetermined shape, a largest dimension less than about 100 micrometers, and a chemically sensitive portion; and
wherein a structure includes a predetermined arrangement of the plurality of particles and a changeable parameter of the structure is configured to change in response to a chemical stimulus.

16. The structure of claim 15, wherein the parameter of the structure that changes in response to a chemical stimulus includes an optical, physical, chemical, or electrical parameter of the structure.

17. The structure of claim 16, wherein the changed parameter is selected from the group consisting of refractive index, reflectiveness, diffraction, color, transmission, translucence, and opaqueness.

18. The structure of claim 15, wherein the changeable parameter is selected from the group consisting of hardness, toughness, strength, elasticity, density, surface energy, roughness, charge, electric field, hydrophilicity, hydrophobicity, and magnetic field.

19. The structure of claim 15, wherein each particle of the plurality of particles has a cross section, and the predetermined shape of the cross section of each particle of the plurality of particles is selected from the group consisting of a circle, a triangle, a cube, a rectangle, a hexagon, an octagon, a polygon, a parallelogram, a diamond, and a crescent.

20. A physically reactive structure, comprising:
a plurality of particles, wherein each particle of the plurality of particles is configured with a substantially predetermined shape, a largest dimension less than about 100 micrometers, and a physically sensitive component; and
wherein a structure includes a predetermined arrangement of the plurality of particles and a changeable parameter of the structure is configured to change in response to a physical stimulus.

21. The structure of claim 20, wherein the parameter of the structure that changes in response to a physical stimulus includes an optical, physical, chemical, or electrical parameter of the structure.

22. The structure of claim 20, wherein the changed parameter is selected from the group consisting of refractive index, reflectiveness, diffraction, color, transmission, translucence, and opaqueness.

23. The structure of claim 20, wherein the changed parameter is selected from the group consisting of hardness, toughness, strength, elasticity, density, surface energy, roughness, charge, electric field, hydrophilicity, hydrophobicity, and magnetic field.

24. The structure of claim 20, wherein each particle has a cross section, and the predetermined shape of the cross section of each particle of the plurality of particles is selected from the group consisting of a circle, a triangle, a cube, a rectangle, a hexagon, an octagon, a polygon, a parallelogram, a diamond, and a crescent.
